(19) United States
(12) Patent Application Publication
(10) Pub. No.: US 2017/0069156 A1
(43) Pub. Date: Mar. 9, 2017

(54) COIN HOPPER

(71) Applicant: Asahi Seiko Co., Ltd., Tokyo (JP)

(72) Inventors: Hiroshi Abe, Saitama-shi (JP); Masayoshi Umeda, Saitama-shi (JP)

(21) Appl. No.: 14/991,122

(22) Filed: Jan. 8, 2016

(30) Foreign Application Priority Data
Sep. 9, 2015 (JP) 2015-177922

(51) Int. Cl. G07D 9/04; F16H 55/06; F16H 57/08; G07D 9/00; F16H 1/28

(52) U.S. Cl. CPC G07D 9/04; G07D 9/008; G07D 9/002; F16H 1/28; F16H 57/082; F16H 55/06

(57) ABSTRACT

A coin hopper is capable of simultaneously realizing high reliability, long lifetime, low cost and downsizing at a level equal to or higher than the prior art. A rotating disk, an electric motor, and a rotating disk driving mechanism for driving the disk by rotation of an output shaft of the motor are provided. The driving mechanism includes a planetary gear mechanism for generating an output by decelerating a rotation of the output shaft at a first reduction ratio, and a first gear train for transmitting the output of the planetary gear mechanism to the disk after decelerating the output of the planetary gear mechanism at a second reduction ratio. The output shaft, the rotation axis of the disk, and the rotation axis of each gear of the first gear train are extended approximately parallel to each other and not coaxially.

### BACKGROUND OF THE INVENTION

1. Field of the Invention

The present invention relates to a coin hopper for dispensing bulk-stored coins one by one and more particularly, to a compact small-sized coin hopper that is preferably used with a variety of machines using coins, such as vending machines, money changers, and change machines.

The term “coin” used in this specification includes not only coins as currency but also tokens and medals for gaming machines as a substitute of currency.

2. Description of Related Art

Conventionally, as a first prior art of the present invention, a coin hopper apparatus is known, as disclosed, for example, in the Japanese unexamined Patent Publication No. 2000-132723 issued on May 12, 2000 (see FIGS. 1 to 3 and Paragraphs 0005, 0007, 0008, 0012, and 0013). This apparatus comprises electric motor means having a rotating shaft whose protruding end is placed in a downward direction; first gear means fixed to the protruding end of the rotating shaft; disk means, which is provided at a bottom of a hopper for storing coins, for ejecting the coins one by one; second gear means for rotating the disk means; and gear train means for connecting the second gear means with the first gear means.

As a second prior art of the present invention, a circular plate ejecting apparatus is known, as disclosed, for example, in the Japanese Patent No. 3516008 issued on Jan. 30, 2004 (see FIGS. 1 to 3 and Paragraphs 0006 to 0008). This apparatus comprises a planetary gear device having a carrier plate which is located and rotated coaxially with a rotation axis of a motor.

With the aforementioned coin hopper apparatus as the first prior art, the protruding end of the rotating shaft of the motor is placed in a downward direction, in other words, the motor is place upside down, and therefore, the height of the coin hopper apparatus can be lowered. However, the first gear means fixed to the rotating shaft of the motor and the second gear means for rotating the disk means are connected by the gear train means. Thus, in the case where the ratio of the rotation speed of the motor and that of the disk means is large, the diameters of the gears constituting the gear train means are large and as a result, the width and depth of the coin hopper apparatus will be large.

If the diameters of the gears constituting the gear train means are decreased while considering the width and depth of the coin hopper apparatus, the tooth widths of these gears needs to be small in order to realize a desired reduction ratio. In this case, tooth-chipping is likely to occur and the reliability and lifetime of the gears will 5 deteriorate. On the other hand, if the diameters of the gears are decreased while keeping their tooth widths, the reduction ratio decreases and a desired reduction ratio cannot be obtained.

If the number of the gear stages is increased, the reduction ratio can be increased; however, if so, the gear train means becomes large and the cost becomes high. Thus, this is unable to be adopted readily.

To realize a desired reduction ratio while preventing the deterioration of the reliability and lifetime of the gears, the diameters of the gears may be decreased if these gears are made of metal. However, if so, the cost is raised and thus, this is unable to be adopted readily.

In this way, there is a problem that a limitation exists in further downsizing the aforementioned coin hopper apparatus as the first prior art.

With the aforementioned circular plate ejecting apparatus as the second prior art, the carrier plate of the planetary gear device is fitted into the rotating shaft of the disk and therefore, the output shaft of the motor and the rotating shaft of the disk are coaxially fixed. For this reason, there is a problem that the height of the aforementioned circular plate ejecting apparatus cannot be decreased so as to be lower than the overall height of the combination of the motor and the output shaft thereof.

### SUMMARY OF THE INVENTION

The present invention was created to solve the abovementioned problems, and an object of the present invention is to provide a coin hopper including a compact coin hopper format of a combination of housing components capable of simultaneously realizing high reliability and long lifetime (long life) at a low manufacturing cost while accomplishing compact downsizing at a level equal to or higher than the aforementioned first and second prior art.

The above object together with others not specifically mentioned will become clear to those skilled in the art from the following description.

A coin hopper according to the present invention comprises:

a body section;

a hopper head for storing coins, attached to the body section;

a rotating disk for temporarily holding coins stored in the hopper head to transfer the coins toward a predetermined coin outlet, wherein the rotating disk is rotatably provided on the body section;

an electric motor provided on the body section; and

a rotating disk driving mechanism for driving the rotating disk by rotation of an output shaft of the motor, wherein the rotating disk driving mechanism is provided on the body section; wherein the rotating disk driving mechanism comprises a planetary gear mechanism for generating an output by decelerating rotation of the output shaft of the motor at a first reduction ratio, and a first gear train for transmitting the output of the planetary gear mechanism to the rotating disk after decelerating the output of the planetary gear mechanism at a second reduction ratio; the output shaft of the motor and a rotation axis of the rotating disk are arranged so as not to be coaxial; and

the output shaft of the motor, the rotation axis of the rotating disk, and a rotation axis of each gear of the first gear train are arranged so as to be approximately parallel to each other.

With the coin hopper according to the present invention, as explained above, the rotating disk driving mechanism is provided to drive the rotating disk by the rotation of the output shaft of the motor, and the rotating disk driving mechanism includes the planetary gear mechanism for decelerating the rotation of the output shaft of the motor at the first reduction ratio, and the first gear train for transmitting the output of the planetary gear mechanism to the rotating disk after decelerating the output of the planetary gear mechanism at the second reduction ratio. Since it is general that the planetary gear mechanism has an advantage that a large reduction ratio is realized and that abrasion and tooth-chipping of the gears used are suppressed, the value of the first reduction ratio and that of the second reduction ratio can be determined in such a way that a greater part (most) of a desired reduction ratio is realized from only the first reduction ratio of the planetary gear mechanism. For this reason, the maximum diameter of the gears that constitute the first gear train can be made smaller compared with the gears used in the aforementioned first prior art.

Similarly, the diameters of the gears of the planetary gear mechanism also can be made smaller than the gears used in the first prior art.

Accordingly, the size of the rotating disk driving mechanism in a direction perpendicular to the rotation axis of each gear of the first gear train (e.g., in a horizontal direction) can be decreased compared with the aforementioned first prior art.

Moreover, the output shaft of the motor and the rotation axis of the rotating disk are arranged so as not to be coaxially, and the output shaft of the motor, the rotation axis of the planetary gear mechanism, and the rotation axis of each gear of the first gear train are arranged to be approximately parallel to each other. For this reason, for example, if the motor and the disk are arranged to be adjacent to each other, and the output shaft of the motor is located to be coaxial with the rotation axis of one gear of the first gear train (e.g., the input side gear) by way of the planetary gear mechanism while facing the output shaft of the motor toward the side of the rotating disk driving mechanism, and further, the rotation shaft of the disk and the rotation axis of another gear of the first gear train (e.g., the output side gear) are arranged to be coaxially with each other, the size of each gear of the first gear train in a direction parallel to the rotation axis of each gear (e.g., in a vertical direction) can be decreased also compared with the aforementioned second prior art.

Accordingly, downsizing at a level equal to or higher than the aforementioned first and second prior art can be accomplished.

Furthermore, since abrasion and tooth-chipping of the gears used for the planetary gear mechanism can be suppressed, the planetary gear mechanism has an advantage of high reliability and long lifetime without using expensive metallic gears. Moreover, since the maximum diameter of the gears that constitute the first gear train can be decreased, abrasion and tooth-chipping of the gears used for the first gear train can be suppressed also, which means that the first gear train also have an advantage of high reliability and long lifetime without using expensive metallic gears.

Accordingly, high reliability and long lifetime of the rotating disk driving mechanism (and therefore, the coin hopper itself) can be simultaneously realized while suppressing the costs of the planetary gear mechanism and the first gear train by using synthetic resin gears.

Because of the above-described reason, in the coin hopper according to the present invention, high reliability and long lifetime can be simultaneously realized at a low cost while accomplishing downsizing at a level equal to or higher than the aforementioned first and second prior art.

In a preferred embodiment of the coin hopper according to the present invention, the output shaft of the motor is coupled with a sun gear of the planetary gear mechanism, and a carrier plate of the planetary gear mechanism is structured in such a way as to be rotated integrally with a driving gear of the first gear train.

In another preferred embodiment of the coin hopper according to the present invention, the rotation disk is structured in such a way as to be rotated integrally with a driven gear of the first gear train.

In still another preferred embodiment of the coin hopper according to the present invention, a driving gear of the first gear train is structured in such a way as to be rotated integrally with a carrier plate of the planetary gear mechanism, and a driven gear of the first gear train is structured in such a way as to be rotated integrally with the rotating disk; wherein rotation of the driving gear is transmitted to the driven gear directly or by way of an intermediate gear.

In a further preferred embodiment of the coin hopper according to the present invention, a driving gear of the first gear train is structured in such a way as to be rotated integrally with a carrier plate of the planetary gear mechanism, and a driven gear of the first gear train is structured in such a way as to be rotated integrally with the rotating disk; wherein rotation of the driving gear is transmitted to the driven gear by way of a first intermediate gear and a second intermediate gear which are coaxially coupled with each other; and wherein the first intermediate gear is meshed with the driving gear and the second intermediate gear is meshed with the driven gear, thereby transmitting rotation of the driving gear to the driven gear.

In a further preferred embodiment of the coin hopper according to the present invention, the motor is fixed to the body section in such a way that the output shaft of the motor is oriented downward; a sun gear of the planetary gear mechanism is placed near the output shaft; and the output shaft is directly coupled with the sun gear.

In a further preferred embodiment of the coin hopper according to the present invention, the output shaft of the motor is connected to a sun gear of the planetary gear mechanism; and a carrier plate of the planetary gear mechanism is placed on a side distant from the output shaft of the motor.

In a further preferred embodiment of the coin hopper according to the present invention, the output shaft of the motor is connected to a sun gear of the planetary gear mechanism; a carrier plate of the planetary gear mechanism is placed on a side distant from the output shaft of the motor; and a driving gear of the first gear train is fixed to the carrier plate.

In a further preferred embodiment of the coin hopper according to the present invention, the output shaft of the motor is connected to a sun gear of the planetary gear mechanism; a carrier plate of the planetary gear mechanism is placed on a side distant from the output shaft of the motor; a driving gear of the first gear train is fixed to the carrier plate; a driven gear of the first gear train is structured in such a way as to be rotated to be integrally with the rotating disk; and rotation of the driving gear is transmitted to the driven gear directly or by way of an intermediate gear.

In a further preferred embodiment of the coin hopper according to the present invention, the first gear train comprises a driving gear which is rotated integrally with a carrier plate of the planetary gear mechanism; a driven gear which is rotated integrally with the rotating disk; a first intermediate gear and a second intermediate gear which are coupled coaxially with each other are provided for transmitting rotation of the driving gear to the driven gear; the driving gear and the first intermediate gear are placed in a first plane and meshed with each other; and the driven gear and the second intermediate gear are placed in a second plane which is parallel to the first plane and meshed with each other.

In a further preferred embodiment of the coin hopper according to the present invention, the motor and the rotating disk are horizontally adjacent to each other, and the output shaft of the motor is extended vertically; wherein the output shaft of the motor is coupled with a sun gear of the planetary gear mechanism which is placed under the motor; and a driven gear of the first gear train is placed under the rotating disk.

In a further preferred embodiment of the coin hopper according to the present invention, the first gear train comprises a driving gear connected to the planetary gear mechanism, a first intermediate gear meshed with the driving gear, a second intermediate gear meshed with the first intermediate gear, and a driven gear connected to the rotating disk; wherein a diameter of the first intermediate gear is larger than a diameter of the driving gear; a diameter of the second intermediate gear is smaller than a diameter of the first intermediate gear; and a diameter of the driven gear is larger than a diameter of the first intermediate gear.

In a further preferred embodiment of the coin hopper according to the present invention, the first gear train comprises a first intermediate gear and a second intermediate gear which are coupled together; wherein a diameter of the second intermediate gear is smaller than a diameter of the first intermediate gear; the first intermediate gear and the second intermediate gear are rotated by the output of the planetary gear mechanism; and rotation of the second intermediate gear is transmitted to the rotating disk.

In a further preferred embodiment of the coin hopper according to the present invention, a carrier plate and gears of the planetary gear mechanism are made of synthetic resin, and gears of the first gear train are made of synthetic resin.

In a further preferred embodiment a compact coin hopper is assembled from a combination of individual housing components that are assembled to be stacked together to operatively receive and dispense coins while forming portions of an exterior surface of the compact coin hopper.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings.

FIG. 1 is a perspective view showing the appearance of a coin hopper according to an embodiment of the present invention;

FIG. 2 is a perspective view showing the internal structure of the coin hopper of FIG. 1, where the hopper head is removed and which is seen from an obliquely upward direction;

FIG. 3 is an exploded perspective view showing the internal structure of the coin hopper of FIG. 1, where the hopper head is removed and which is seen from an obliquely upward direction;

FIG. 4 is an exploded perspective view showing the internal structure of the coin hopper of FIG. 1, where the hopper head is removed and which is seen from an obliquely downward direction;

FIG. 5A is a perspective view showing the internal structure of the coin hopper of FIG. 1, which is seen from an obliquely upward direction and where the rotating disk and the upper cover are removed;

FIG. 5B is a perspective view showing the internal structure of the coin hopper of FIG. 1, which is seen from an obliquely downward direction and where the planetary gear mechanism and the first gear train are removed;

FIG. 6A is a plan view showing the structure of the hopper head of the coin hopper of FIG. 1;

FIG. 6B is a cross-sectional view along the line VIBVIB in FIG. 6A;

FIG. 6C is a cross-sectional view along the line VICVIC in FIG. 6A;

FIG. 7A is a perspective view showing the structure of the base member of the coin hopper of FIG. 1, which is seen from an obliquely upward direction;

FIG. 7B is a plan view showing the structure of the base member of the coin hopper of FIG. 1;

FIG. 8 is a plan view showing the internal structure of the body of the coin hopper of FIG. 1, where the hopper head and the upper cover are removed;

FIG. 9A is a left side view showing the structure of the coin hopper of FIG. 1, where the hopper head and the upper cover are removed;

FIG. 9B is a cross-sectional view along the line IXBIXB in FIG. 9A;

FIG. 9C is a cross-sectional view along the line IXCIXC in FIG. 9A;

FIG. 10A is a partial perspective view showing the main parts of the rotating disk driving mechanism of the coin hopper of FIG. 1, where the internal gear of the planetary gear mechanism is omitted and which is seen from an obliquely upward direction; and

FIG. 10B is a partial right side view showing the main parts of the rotating disk driving mechanism of the coin hopper of FIG. 1, where the internal gear of the planetary gear mechanism is omitted.

### DETAILED DESCRIPTION OF THE PREFERRED EMBODIMENTS

Preferred embodiments of the present invention will be described in detail below while referring to the drawings attached.

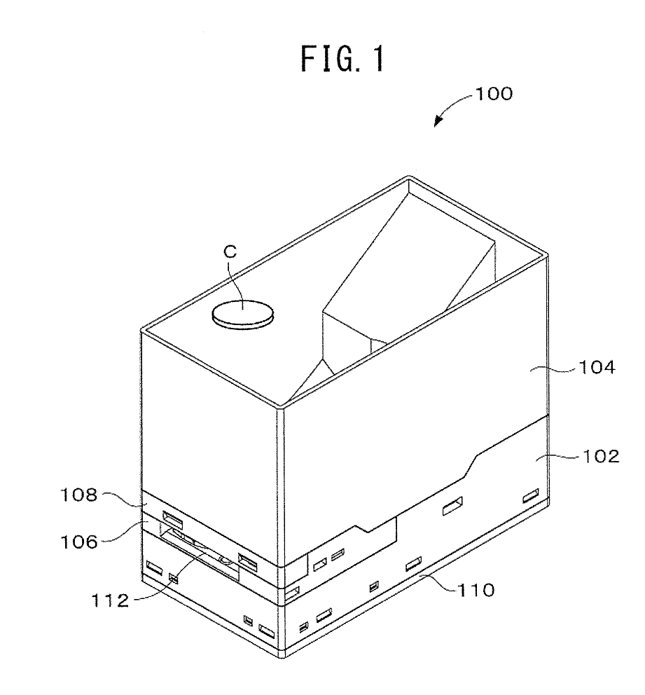

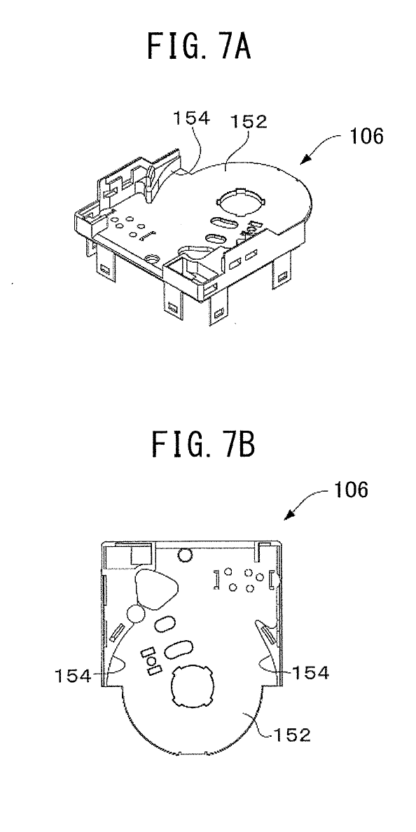

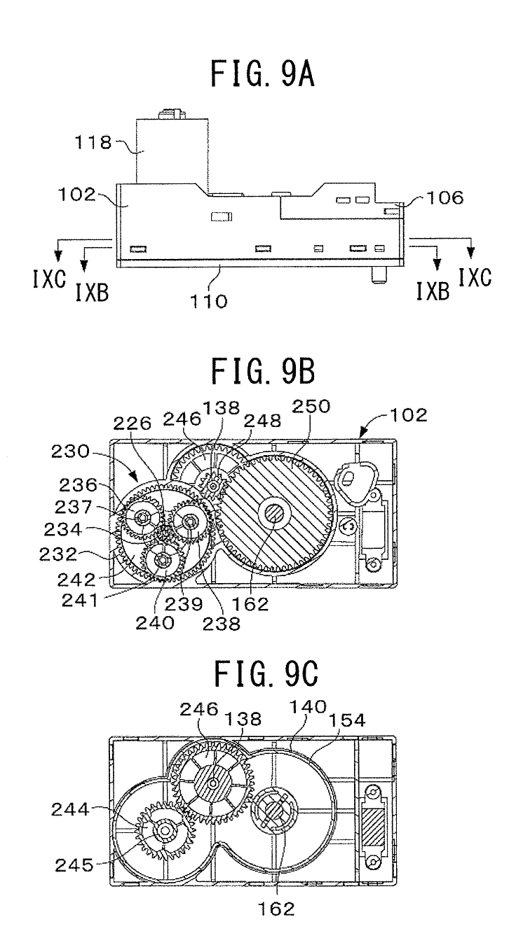

A coin hopper 100 according to an embodiment of the present invention is shown in FIGS. 1 to 10. This coin hopper 100 has the function of separating a plurality of coins C which are stored in bulk in a hopper head 104 and of dispensing the coins C thus separated one by one through a coin outlet 112 which is formed on one side face of the hopper 100.

As shown in FIGS. 1 to 4, the coin hopper 100 comprises mainly a body 102, the hopper head 104 detachably attached to the upper surface of the body 102, a base member 106 attached to the body 102, an upper cover 108 placed between the base member 108 and the hopper head 104 to cover a part of the body 102, and a lower cover 110 attached to the lower surface of the body 102 to cover the entirety of the said lower surface.

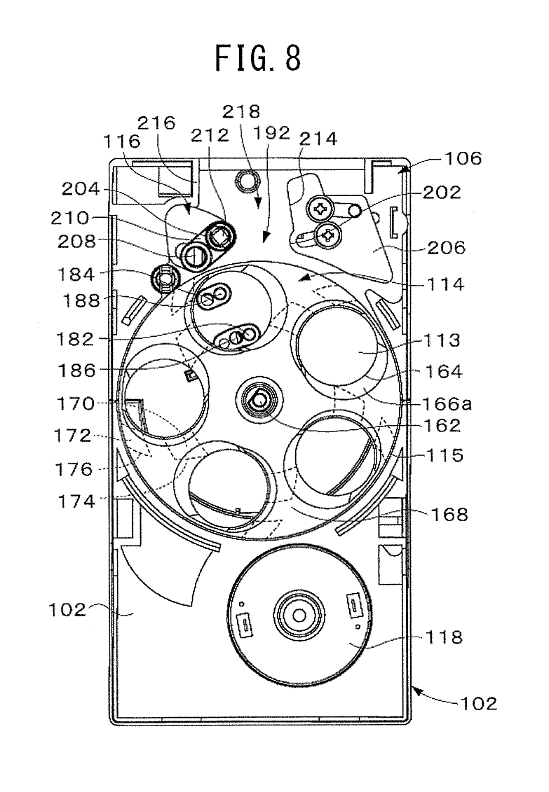

The coin hopper 100 further comprises a rotating disk 114 placed rotatably on the base member 106, a coin ejection part or section 116 (FIG. 8), an electric motor 118, and a rotating disk driving mechanism 120, which will be explained in detail later.

In this embodiment, the combination of the body 102 and the base member 106 constitutes a “body section” of the coin hopper 100. This “body section,” which has the structure to which the hopper head 104 is attachable, means the section (part) on which the rotating disk 114, the motor 118, and the rotating disk driving mechanism 120 are mounted.

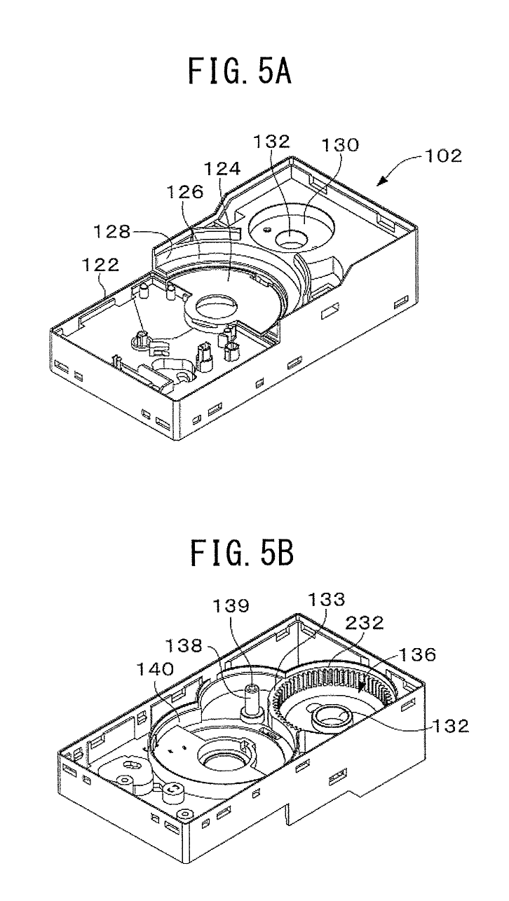

The body 102 has the overall structure shown in FIG. 5 and supports the hopper head 104, the base member 106, the rotating disk 114, and the electric motor 118. The body 102 is formed by injection molding using a synthetic resin and has a box-like shape which is rectangular in a plan view.

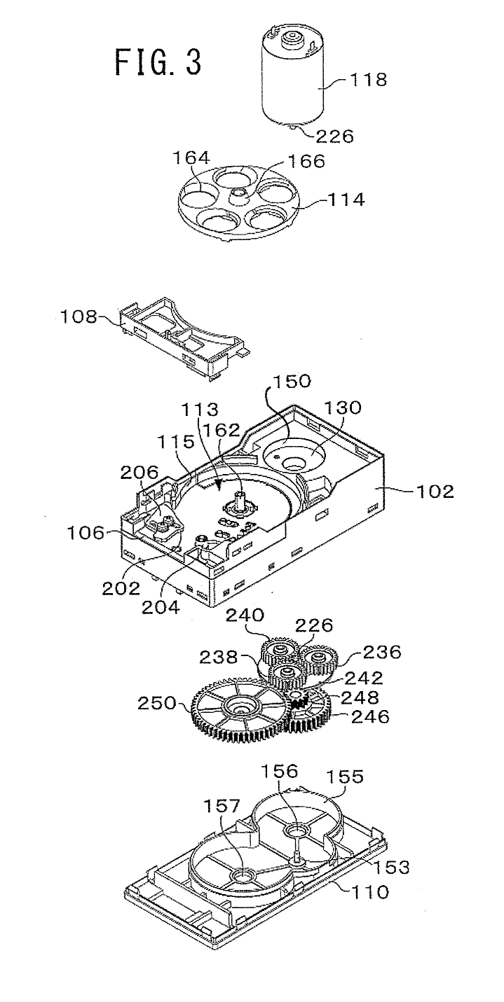

As clearly shown in FIG. 5A, on the surface side (upper side) of the body 102, a frame 122 for placing the base member 106, and a placement part 124 having a semi-annular shape in a plan view are formed. The frame 122 and the placement part 124 are flush with each other. A bottom wall 126 having a semi-annular shape in a plan view, which will be approximately flush with the base member 106 when the base member 106 is placed on the body 102, is formed around the placement part 124. A side wall 128, which is arc-shaped in a plan view and which extends vertically, is formed to be integrated with the bottom wall 126 in the periphery of the bottom wall 126. A depressed part 130 for supporting the motor 118 in its inverted situation, that is, in the situation where the output shaft 226 of the motor 118 is oriented downward (see FIG. 3), is formed on the outside of the sidewall 128. A through hole 132 for enabling the output shaft 226 to protrude to the back 15 side (lower side) of the body 102 is formed in the central area of the depressed part 130.

As clearly shown in FIG. 5B, on the back side (lower side) of the body 102, a cylindrical part 133 is formed. On the internal wall of this cylindrical part 133, an internal gear 232 that constitutes a part of a planetary gear mechanism 230 which will be described later is formed. The internal gear 232 has a plurality of inward-pointing teeth formed on the inner wall of the cylindrical part 133. In the cylindrical part 133, a space 136 for receiving a sun gear 234 and three planetary gears 236, 238, and 240 which will be described later is formed. A support shaft 138 for rotatably supporting a first intermediate gear 246 and a second intermediate gear 248 (both of which constitute part of a first gear train 260 which will be explained later) which will be described later are formed in the outer vicinity of the cylindrical part 133. A shaft inserting hole 139 is formed at the middle of the support shaft 138 in such a way that an inserting shaft 153 (see FIG. 3) formed on the lower cover 110 which will be described later is inserted therein. Moreover, a housing wall 140 is further formed in the vicinity of the cylindrical part 133. The housing wall 140 houses a driving gear 244, the first intermediate gear 246, the second intermediate gear 248, and a driven gear 250 that constitute the first gear train 260 in the inside of the said wall 140.

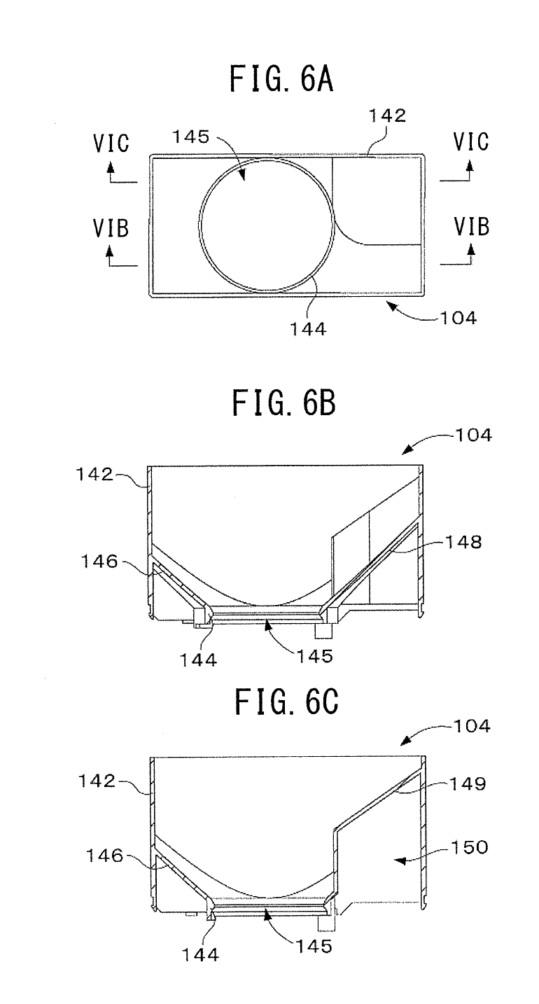

The hopper head 104 is configured to be detachably attached to the body 102 and has the function of storing a predetermined amount of bulk coins C at a position over the rotating disk 114. As shown in FIGS. 1 and 6, the head 104 has a cylindrical shape which is rectangular in a plan view as a whole, and comprises a rectangular wall 142 extending from the top end to the bottom end of the head 104, and a circular wall 144 formed at the lower end of the rectangular wall 142 so as to be positioned inside the said wall 142. The circular wall 144 forms a bottom hole 145 for dropping the coins C which are stored in the head 104 onto the rotating disk 114. Inclined walls 146, 148, and 149, which are provided for connecting smoothly the rectangular wall 142 to the circular wall 144, are formed inside of the intermediate part of the head 104. A motor receiving part 150, which is a space for receiving the motor 118, is formed at a position corresponding to the depressed part 130 of the body 102. The lower end portion of the rectangular wall 142 is configured to be detachably 10 attached to the upper end of the body 102.

As shown in FIGS. 3, 4, and 7, the base member 106 comprises a bottom wall 152 which is placed so as to be flush with the bottom wall 126 of the body 102 when attached to the body 102, and functions as a base 113 (see FIG. 8) that supports one face of a coin C in cooperation with the bottom wall 126. Moreover, the base member 106 comprises arc-shaped side walls 154 which are formed to be continuous with the side wall 128 of the body 102 when attached to the body 102, and which function as a guide wall 115 (see FIG. 8) that guides the peripheral face of a coin C that is moved in conjunction with the rotation of the rotating disk 114 in cooperation with the side wall 128. The base member 106 is configured to be detachably attached to the side of the body 102 on which the coin outlet 112 is formed.

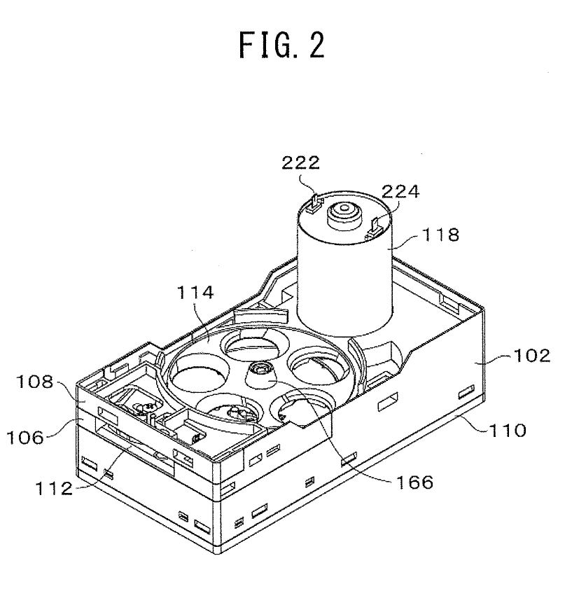

The upper cover 108 has the function of defining the coin outlet 112 in cooperation with the base member 106, as clearly shown in FIG. 2. The upper cover 108 is configured to be detachably attached to the base member 106.

The lower cover 110 has the function of covering the body 102 from its lower side, as shown in FIGS. 3 to 5. An inserting shaft 153 is formed on the upper face of the lower cover 110 (see FIG. 3). The shaft 153 is inserted into a shaft inserting hole 139 formed to penetrate through a supporting shaft 138 of the body 102. Moreover, a housing wall 155 for housing the driving gear 244, the first intermediate gear 246, the second intermediate gear 248, and the driven gear 250 is formed on the lower cover 110. The housing wall 155 has the same plan shape as that of the housing wall 140 formed on the back side of the body 102. When the lower cover 110 is attached to the lower side of the body 102, the housing walls 155 and 140 are fitted to each other.

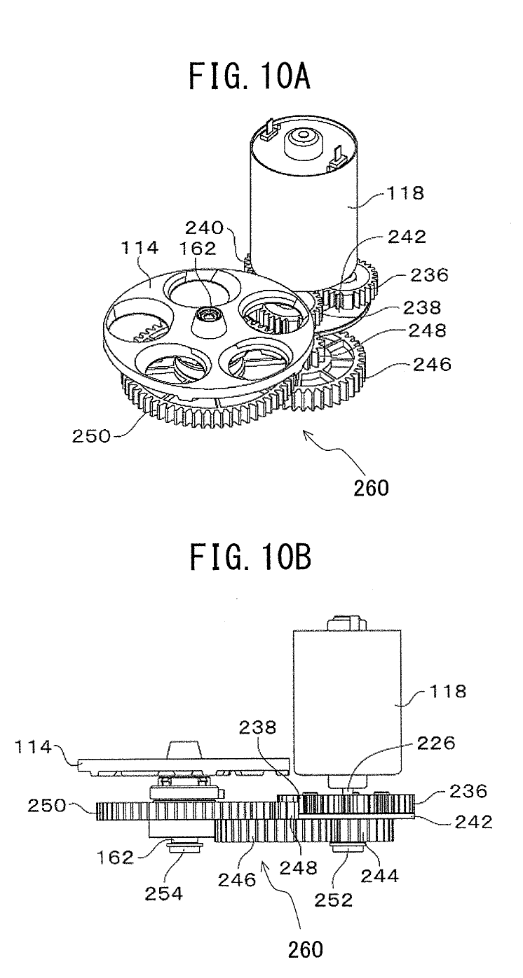

The lower cover 110 further comprises a shaft holding holes 156 and 157. The shaft holding hole 156 is used for holding a supporting shaft 245 which is provided for supporting the driving gear 244, in which a shaft receiver 252 (see FIG. 10B) is engaged with the lower end of the supporting shaft 245 and the shaft receiver 252 thus engaged is further engaged with the lower cover 110 at the shaft holding hole 156. The shaft holding hole 157 is used for holding the lower end of a rotating shaft 162 which is provided for rotating the rotating disk 114, in which a shaft receiver 254 (see FIG. 10B) is engaged with the lower end of the rotating shaft 162 5 and the shaft receiver 254 thus engaged is further engaged with the lower cover 110 at the shaft holding hole 157.

By assembling a combination of housing components in a stacked formation shown in FIG. 1. From housing components shown in FIGS. 2 to 5, an exterior surface represented by a hopper head 104, a body member 104, an upper cover 108, a base member 106, a body member 107 and a lower cover 110 is provided that is suitable for a compact coin dispenser of an economical product cost.

The rotating disk 114 has the function of separating a plurality of coins C which are stored randomly in the hopper head 104 and of conveying the coins C thus separated one by one to the coin ejection section 116 (see FIG. 8) which is formed on the surface side (upper side) of the base member 106, as shown in FIGS. 2, 4, and 8. The disk 114 is like a thin, circular disk and is placed in the bottom hole 145 of the hopper head 104 in such a way as to be parallel to the upper face of the base 113 in the close vicinity of the said upper face. The disk 114 is fixed to the rotating shaft 162 which is drivably connected to the output shaft 226 of the motor 118. The rotating shaft 162 is supported by the shaft receiver 254 which is engaged with the shaft holding hole 157 of the lower 20 cover 110.

The rotating disk 114 is rotated by the rotation of the motor 118 counterclockwise in FIG. 8. This counterclockwise rotation is termed “forward rotation” here. In the case where a coin jam occurs and as a result, the disk 114 is not rotated or any coin C is not dispensed in spite of the forward rotation mode of the motor 118, the rotation of the motor 118 is stopped and then, the disk 114 is rotated clockwise in FIG. 8. This clockwise rotation is termed “reverse rotation” here. This process of forward rotation, reverse rotation, and forward rotation again is repeated predetermined times.

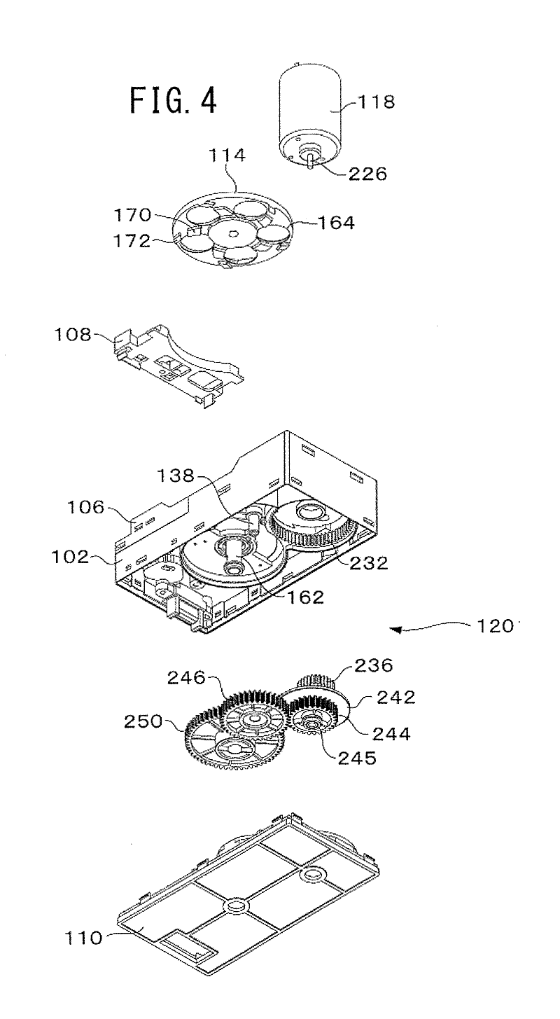

The rotating disk 114 comprises five circular through holes 164 formed at the respective eccentric positions with respect to the rotating shaft 162, in which the through holes 164 are arranged at equal intervals along the circular peripheral edge of the disk 114, as shown in FIG. 4. As shown in FIG. 8, an introducing part 166a, the shape of which is like a part of a downward cone, is formed on the upper peripheral area of each through hole 164. A central protruding part 166, the shape of which is like a truncated cone, is formed at the center of the disk 114 in order to stir the coins C in the state where the disk 114 is rotatably supported by the rotating shaft 162, as shown in FIG. 2. The disk 114 is placed in the inside of the guide wall 115 in such a way that the gap between the disk 114 and the guide wall 115 is smaller than the thickness of a coin C. On the back (lower) side of the disk 114, a first pushing member 170 and a second pushing member 172 for pushing out the coins C are formed on the lower face of each rib 168 that defines the through holes 164 in such a way as to protrude downward and to face on the corresponding hole 164. A first pushing face 174 of the first pushing member 170 and a second pushing face 176 of the second pushing member 1 72 are placed on an involute which extends from the center of the disk 114.

In the case where the rotating disk 114 is rotated in the forward direction, the coins C placed on the disk 114 are stirred by the through holes 164, the central protruding part 166, and so on, which are formed on the upper face of the disk 114 and as a result, the coins C are changed in their attitude and dropped in the respective through holes 164 one by one. The coins C are pushed by the first and second pushing faces 174 and 176 due to the rotation of the disk 114 and moved in conjunction with the rotation of the disk 114 while the lower face of the coin C which is dropped in each hole 164 is guided by the base 113 and the peripheral face of the said coin C is guided by the guide wall 115. At this time, a contact pressure is applied to the guide wall 115 by the peripheral face of the coin C. Most of the contact pressure to the guide wall 115 is caused by a centrifugal force and therefore, the contact pressure will not be large. During the moving process of the coin C in conjunction with the disk 114, the movement of the coin C is blocked by a first regulating pin 182 and a second regulating pin 184 which are formed to protrude upward from the base 113, guided toward the peripheral edge of the disk 114, and finally, pushed into an outlet opening 192.

A first running-aground pin 186 and a second running-aground pin 188 are respectively formed to protrude upward from the base 113 in the vicinities of the first regulating pin 182 and the second regulating pin 184. The first and second running-aground pins 186 and 188 are respectively located at the positions shifted counterclockwise (to the left side in FIG. 8) with respect to the first and second regulating pins 182 and 184, and respectively comprise descending inclined faces formed on the remote sides of the pins 186 and 188 with respect to the first and second regulating pins 182 and 184. When the rotating disk 114 is rotated in the reverse direction, each coin C is pushed by the rear faces (not shown) of the first and second pushing members 170 and 172 and moved clockwise in conjunction with the reverse rotation of the disk 114.

In this case, the coin c is moved onto the first and second running-aground pins 186 and 188 by way of the inclined 20 faces of the pins 186 and 188 and as a result, the coin C is able to pass through the locations which are right above the first and second regulating pins 182 and 184. Since any one of the first and second regulating pins 182 and 184 and the first and second running-aground pins 186 and 188 is engaged with a flat spring (not shown) one end of which is fixed, these pins 182, 184, 186, and 188 are movable downward with respect to the base 113. For this reason, the running-aground of the coin C onto the first and second running-aground pins 186 and 188 5 is promoted and as a result, the coin C can pass easily through the locations which are right above the first and second regulating pins 182 and 184.

As shown in FIG. 8, the coin ejector section or part 116 has the function of ejecting the coins C which have been separated and conveyed one by one by the rotating disk 114 toward the outside of the coin hopper 100 one by one. In this embodiment, the coin ejector section 116 comprises a fixed guide 202 and a movable roller 204. A gap is formed between the guide 202 and the roller 204; this gap serves as the outlet opening 192. The guide 202 is formed by a protruding part of a guide plate 206 which is placed adjacent to the guide wall 115, in which the protruding part protrudes toward the side of the roller 204. The guide plate 206 is fixed to the base member 106. On the other hand, the roller 204 is rockably supported by a supporting shaft 212 which is fixed to the top end of a rocking lever 210. The lever 210 is rockably supported by a supporting shaft 208 which is fixed to the base member 106, and has a rocking force in the clockwise direction in FIG. 8 which is applied by a spring (not shown).

In the case where the movable roller 204 is at the standby position, the spacing between the roller 204 and the guide 202 is kept at an interval which is smaller than the diameter of a coin C to be used. In the case where the coin C guided by the second regulating pin 184 is pushed into the gap between the guide 202 and the roller 204 by the second pushing face 176 of the rotating disk 114, the rocking lever 210 is rocked counterclockwise in FIG. 8. Then, immediately after a line passing through the center of the coin C passes through a contact point between the guide 202 and the roller 204, the coin C is ejected toward the outside of the coin hopper 100 by the roller 204 to which the resilient force of the aforementioned spring is applied.

A linear guide edge 214, which is prepared for guiding the coin C which has been ejected by the coin ejector section 116 to a predetermined direction, is formed so as to be continuous with the guide 202. A guide wall 216 is formed in the vicinity of the coin outlet 112 of the base member 106. The guide edge 214 and the guide wall 216 are opposed to each other, thereby defining an output passage 218 at a location over the base 113. The coin C which has been ejected by the coin ejection section 116 is moved through the inside of the outlet passage 218 along the guide edge 214 of the guide plate 206 and is dispensed through the coin outlet 112 which is formed on one side face of the base member 106.

The electric motor 118 is a driving source for rotating the disk 114 by way of the rotating disk driving mechanism 120 which will be explained later. The motor 118 is inserted into the depressed part 130 of the body 102 in its inverted situation where the output shaft 226 is oriented downward and is fixed to the upper face of the body 102. When the hopper head 104 is attached to the body 102, the body of the motor 18 is received in the motor receiving part 150 of the head 104. In this embodiment, the motor 118 is a direct current motor capable of forward and reverse rotations. As shown in FIGS. 2 to 4, the motor 118 comprises a pair of input terminals 222 and 224 for supplying electric power to the motor 118 at one end (here, the upper end), and the output shaft 226 for outputting a mechanical driving force (rotating force) is protruded at the other end (here, the lower end).

Next, the rotating disk driving mechanism 120 will be explained below with reference to FIGS. 3 to 5 and FIGS. 9 and 10.

The rotating disk driving mechanism 120 has the function of transmitting the rotation (driving force) of the output shaft 226 of the motor 118 to the rotation shaft 162 for the rotating disk 114 after reducing the rotation speed of the output shaft 226, thereby rotating the disk 114 at a predetermined rotation speed. In this embodiment, the rotating disk driving mechanism 120 comprises the planetary gear mechanism 230 and the first gear train 260.

The planetary gear mechanism 230 has the function of reducing the rotation speed of the output shaft 226 of the motor 118 at a predetermined first reduction ratio, thereby rotating the carrier plate 242 at a predetermined rotation speed. Here, this mechanism 230 comprises the internal gear 232, the sun gear 234, the three planetary gears 236, 238, and 240, and the carrier plate 242. The rotation of the output shaft 226 of the motor 118 is inputted into the sun gear 234, and the rotation speed of the output shaft 226 is reduced in the mechanism 230; thereafter, the resultant rotation of the mechanism 230 is outputted from the carrier plate 242.

The first gear train 260 has the function of reducing the rotation speed of the carrier plate 242 as the output of the planetary gear mechanism 230 at a predetermined second reduction ratio, thereby rotating (the rotating shaft 162 for) the rotating disk 114 at a predetermined rotation speed. Here, the train 260 comprises the driving gear 244, the first intermediate gear 246, the second intermediate gear 248, and the driven gear 250. The rotation of the carrier plate 242 as the output of the planetary gear mechanism 230 is inputted into the driving gear 244 (input gear) provided on the input side, and reduced in the first gear train 260, and outputted from the driven gear 250 (output gear) provided on the output side. The rotating disk 114 is drivably rotated by the rotation of the driven gear 250 thus outputted.

Next, the structures of the aforementioned planetary gear mechanism 230 and the first gear train 260 will be explained below in more detail with reference to the figures attached.

The internal gear 232 of the planetary gear mechanism 230, which has a predetermined number of internal teeth, is formed so as to be integrated with the body 102 on the back side of the body 102 (See FIGS. 4 and 5). In the space 136 formed on the inside of the internal gear 232, the sun gear 234, the three planetary gears 236, 238, and 240, and the carrier plate 242 are arranged. All of the sun gear 234, the planetary gears 236, 238, and 240, and the carrier plate 242 are made of synthetic resin. The rotation axis of the internal gear 232 and that of the sun gear 234 are coaxial with the rotation axis of the output shaft 226 of the motor 118. The internal gear 232 and the sun gear 234 are placed below the output shaft 226. The rotation axis of the planetary gear mechanism 230 is concentric with the rotation axis of the internal gear 232 and that of the sun gear 234. The output shaft 226 of the motor 118 is inserted into a shaft inserting hole of the sun gear 234 which is formed on the rotation axis of the sun gear 234, and fixed to the said shaft inserting hole. The carrier plate 242, the shape of which is like a thin circular disk, is also coaxial with the output shaft 226 of the motor 118. Therefore, the rotation axis of the carrier plate 242 is concentric with the rotation axis of the planetary gear mechanism 230, that of the internal gear 232, and that of the sun gear 234.

The three planetary gears 236, 238, and 240 are arranged in the space between the internal gear 232 and the sun gear 234 so as to have a layout shown in FIG. 3. The planetary gears 236, 238, and 240 are meshed with the internal gear 232 on their outside and at the same time, are meshed with the sun gear 234 on their inside. The planetary gears 236, 238, and 240 are rotatably supported by their supporting shafts 237, 239, and 241 which are fixed on the carrier plate 242, respectively. The planetary gears 236, 238, and 240 revolve respectively on their supporting shafts 237, 239, and 241 in conjunction with the rotation of the sun gear 234 and at the same time, the gears 236, 238, and 240 revolve around the rotation axis of the sun gear 234. In addition, the three supporting shafts 237, 239, and 241 are arranged at equal intervals around the rotation axis of the carrier plate 242 (the planetary gear mechanism 230) and therefore, the three planetary gears 236, 238, and 240 are also arranged at equal intervals around the rotation axis of the carrier plate 242 (the planetary gear mechanism 230).

Since the planetary gear mechanism 230 has the aforementioned structure, the rotation of the output shaft 226 of the motor 118 which is placed coaxially with the planetary gear mechanism 230 can be reduced at the predetermined first reduction ratio, thereby rotating the carrier plate 242 which is placed coaxially with the output shaft 226 at the predetermined rotation speed. A planetary gear mechanism generally has an advantage that a large reduction ratio can be realized and that abrasion and tooth-chipping of the gears used can be suppressed. Thus, the value of the first reduction ratio can be set as large as possible in such a way that a greater part (most) of the desired reduction ratio is realized only by the first reduction ratio of the planetary gear mechanism 230.

All of the driving gear 244, the first intermediate gear 246, the second intermediate gear 248, and the driven gear 250 that constitute the first gear train 260 are made of synthetic resin.

The driving gear 244 is placed coaxially with the carrier plate 242 of the planetary gear mechanism 230 on the back side (lower side) of the carrier plate 242. In this embodiment, the driving gear 244 is formed to be integrated with the carrier plate 242, and the supporting shaft 245 for the driving gear 244 is also formed to be integrated with the driving gear 244. The lower end of the supporting shaft 245 for the driving gear 244 is rotatably held by the lower cover 110 by way of the shaft receiver 252 at the shaft holding hole 156 (see FIG. 3) of the lower cover 110. Due to such the structure as described here, the carrier plate 242 and the driving gear 244 can be rotated integrally around the supporting shaft 245.

The first intermediate gear 246 is placed adjacent to the driving gear 244 in the same horizontal plane as the driving gear 244 and is meshed with the driving gear 244. The diameter of the first intermediate gear 246 is larger than that of the driving gear 244. The second intermediate gear 248 is placed right over the first intermediate gear 246 and fixed thereto.

The second intermediate gear 248 is placed coaxially with the first intermediate gear 246 and is formed to be integrated with the first intermediate gear 246. The first and second intermediate gears 246 and 248 have a common shaft inserting hole into which the supporting shaft 138 which is formed on the body 102 is inserted. Because of this structure, the first and second intermediate gears 246 and 248 can be rotated integrally around the supporting shaft 138 while rotatably supporting the first and second intermediate gears 246 and 248 by the supporting shaft 138. The diameter of the second intermediate gear 248 is smaller than that of the first intermediate gear 246.

The second intermediate gear 248 is placed in the same horizontal plane as the planetary gears 236, 238, and 240 of the planetary gear mechanism 230. The second intermediate gear 248 is also placed in the same horizontal plane as the sun gear 234 and the internal gear 232 of the planetary gear mechanism 230 also.

The driven gear 250 is placed adjacent to the second intermediate gear 248 in the same horizontal plane as the second intermediate gear 248 and meshed with the second intermediate gear 248. The diameter of the driven gear 250 is larger than that of the second intermediate gear 248. The rotating shaft 162 for the rotating disk 114 is inserted into a shaft inserting hole which is formed on the rotation axis of the driven gear 250, and fixed to the said shaft inserting hole. The lower end of the rotating shaft 162 is rotatably held by the lower cover 110 by way of the shaft receiver 254 at the shaft holding hole 157 (see FIG. 3) of the lower cover 110. Due to such the structure as described here, the rotating disk 114 and the driven gear 250 can be rotated integrally with the shaft 162.

The second reduction ratio of the first gear train 260 can be set at a small value (which is close to 1). This is because the value of the first reduction ratio of the planetary gear mechanism 230 can be set as large as possible in such a way that a greater part (most) of the desired reduction ratio is realized only by the first reduction ratio of the planetary gear mechanism 230.

In the rotating disk driving mechanism 120 (i.e., the combination of the planetary gear mechanism 230 and the first gear train 260) having the aforementioned structures and functions, if the output shaft 226 of the electric motor 118 is rotated at the predetermined rotation speed, the driving force (rotating force) of the output shaft 226 is outputted from the carrier plate 242 after the rotation speed of the output shaft 226 is reduced at the first reduction ratio by the planetary gear mechanism 230. Then, the driving force which has been reduced and outputted from the carrier plate 242 is further reduced at the second reduction ratio by the first gear train 260 and thereafter, transmitted to the rotating disk 114. In this way, the disk 114 is rotated at the rotation speed which has been realized by largely reducing the rotation speed of the output shaft 226 of the motor 118 through two stages.

With the coin hopper 100 according to the embodiment of the present invention, as explained above, there are provided with the hopper head 104 which is attached to the body section (i.e., the combination of the body 102 and the base member 106); the rotating disk 114 for temporarily holding the coins C stored in the hopper head 104 and transferring the coins C toward the predetermined coin outlet 112; the electric motor 118 provided on the body section; and the rotating disk driving mechanism 120 for driving the rotating disk 114 by the rotation of the output shaft 226 of the motor 118, wherein the rotating disk driving mechanism 120 is provided on the body section.

The rotating disk driving mechanism 120 comprises the planetary gear mechanism 230 for generating the output of the mechanism 120 by decelerating the rotation of the output shaft 226 of the motor 118 at the first reduction ratio, and the first gear train 260 for transmitting the output of the planetary gear mechanism 230 to the disk 114 after decelerating the output of the planetary gear mechanism 230 at the second reduction ratio.

The output shaft 226 of the motor 118 and the rotation axis of the rotating disk 114 are adjacently arranged at the positions which are shifted to each other in the direction perpendicular to the output shaft 226 (i.e., in the horizontal direction). This means that the output shaft 226 of the motor 118 and the rotation axis of the disk 114 are not placed coaxially.

The output shaft 226 of the motor 118, the rotation axis of the rotating disk 114, and the rotation axis of each gear 244, 246, 248, or 250 of the first gear train 260 are extended in parallel to the output shaft 226 (vertically). This means that the output shaft 226 of the motor 118, the rotation axis of the rotating disk 114, and the rotation axis of each gear of the first gear train 260 are extended in parallel to each other.

Accordingly, with the coin hopper 100 according to this embodiment, the rotating disk driving mechanism 120 is provided for driving the rotating disk 114 by the rotation of the output shaft 226 of the motor 118, and the rotating disk driving mechanism 120 comprises the planetary gear mechanism 230 for decelerating the rotation of the output shaft 226 of the motor 118 at the first reduction ratio, and the first gear train 260 for transmitting the output of the planetary gear mechanism 230 to the rotating disk 114 after decelerating the output of the planetary gear mechanism 230 at the second reduction ratio. Since it is general that the planetary gear mechanism 230 has an advantage that a large reduction ratio is realized and that abrasion and tooth-chipping of the gears 244, 246, 248, and 250 used are suppressed, the value of the first reduction ratio and that of the second reduction ratio can be determined in such a way that a greater part (most) of a desired reduction ratio is realized from only the first reduction ratio of the planetary gear mechanism 230. For this reason, the maximum diameter of the gears 244, 246, 248, and 250 that constitute the first gear train 260 can be made smaller compared with the gears used in the aforementioned first prior art. Similarly, the diameters of the gears 234, 236, 238, and 240 of the planetary gear mechanism 230 also can be made smaller than the gears used in the first prior art.

Consequently, the size of the rotating disk driving mechanism 120 in a direction perpendicular to the rotation axis of each gear of the first gear train 260 can be decreased compared with the first prior art.

Moreover, the output shaft 226 of the motor 118 and the rotation axis of the rotating disk 114 are shifted in the horizontal direction so as not to be coaxial with each other, and the output shaft 226 of the motor 118, the rotation axis of the planetary gear mechanism 230, and the rotation axis of each gear of the first gear train 260 are arranged to be approximately parallel to each other. For this reason, for example, as shown in this embodiment, if the motor 118 and the disk 114 are arranged adjacent to each other, and the output shaft 226 of the motor 118 is set to be coaxial with the rotation axis of one gear of the first gear train 260 (e.g., the input side gear 244) while facing the output shaft 226 toward the side of the rotating disk driving mechanism 120, and furthermore, the rotation axis of the disk 114 and the rotation axis of another gear of the first gear train 260 (e.g., the output side gear 250) are located to be coaxially with each other, the size of each gear of the first gear train 260 in a direction parallel to the rotation axis of each gear of the first gear train 260 can be decreased also.

Accordingly, downsizing at a level equal to or higher than the aforementioned first and second prior art can be accomplished.

Furthermore, since abrasion and tooth-chipping of the gears 234, 236, 238, and 240 used for the planetary gear mechanism 230 can be suppressed, the planetary gear mechanism 230 will have an advantage of high reliability and long lifetime without using expensive metallic gears. Moreover, since the maximum diameter of the gears 244, 246, 248, and 250 that constitute the first gear train 260 can be decreased, abrasion and tooth-chipping of the gears 244, 246, 248, and 250 used for the first gear train 260 can be suppressed also, which means that the first gear train 260 also will have an advantage of high reliability and long lifetime without using expensive metallic gears. Accordingly, high reliability and long lifetime of the rotating disk driving mechanism 230 (and therefore, the coin hopper 100 itself) can be simultaneously realized while suppressing the cost of the planetary gear mechanism 230 and the first gear train 260 by using synthetic resin gears.

In the coin hopper 100 according to this embodiment, because of the above-described reason, high reliability and long lifetime (long life) can be simultaneously realized at a low cost while accomplishing downsizing at a level equal to or higher than the aforementioned first and second prior art.

Variations

It is needless to say that the present invention is not limited to the above-described embodiment and its variations. Any other modification is applicable to the embodiment and variations.

For example, in the aforementioned coin hopper 100 according to the embodiment of the present invention, the carrier plate 242 of the planetary gear mechanism 230 and the driving gear 244 of the first gear train 260 are integrated with each other and the first and second intermediate gears 246 and 248 of the first gear train 260 are integrated with each other. However, the carrier plate 242 and the driving gear which have been formed separately may be combined together and the first and second intermediate gears 246 and 248 which have been formed separately may be combined together. However, integral formation is preferred from the viewpoint of cost reduction.

Moreover, in the case where a desired reduction ratio can be realized only by the planetary gear mechanism 230 and the driving and driven gears 244 and 250 of the first gear train 260 and at the same time, the occupation area of the planetary gear mechanism 230 and the driving and driven gears 244 and 250 can be set at a desired value, the driving gear 244 may be directly meshed with the driven gear 250 while omitting the aforementioned first and second intermediate gears 246 and 148. In this case, the first gear train 160 is constituted by only the driving gear 244 and the driven gear 250.

Although the body 102 and the base member 106 are separately formed in the aforementioned embodiment, it is needless to say that they may be formed integrally.

Furthermore, the rotating disk driving mechanism 120 is not limited to the combination of the planetary gear mechanism 230 and the first gear train 260. The rotating disk driving mechanism 120 may include another gear train (e.g., a second gear train) in addition to the combination of the planetary gear mechanism 230 and the first gear train 260. The structure of the planetary gear mechanism 230 also may be optionally changed if a desired reduction ratio can be realized. The structure of the first gear train 260 may be optionally changed if a desired reduction ratio can be realized.

While the preferred forms of the present invention have been described, it is to be understood that modifications will be apparent to those skilled in the art without departing from the spirit of the invention. The scope of the present invention, therefore, is to be determined solely by the following claims.

What is claimed is:

1. A coin hopper comprising:
a body section;
a hopper head for storing coins, attached to the body section;
a rotating disk for temporarily holding coins stored in the hopper head to transfer the coins toward a predetermined coin outlet, wherein the rotating disk is rotatably provided on the body section;
an electric motor provided on the body section; and a rotating disk driving mechanism for driving the rotating disk by rotation of an output shaft of the motor, wherein the rotating disk driving mechanism is provided on the body section; wherein the rotating disk driving mechanism comprises a planetary gear mechanism for generating an output by decelerating rotation of the output shaft of the motor at a first reduction ratio, and a first gear train for transmitting the output of the planetary gear mechanism to the rotating disk after decelerating the output of the planetary gear mechanism at a second reduction ratio; the output shaft of the motor and a rotation axis of the rotating disk are arranged so as not to be coaxially; and
the output shaft of the motor, the rotation axis of the rotating disk, and a rotation axis of each gear of the first gear train are arranged so as to be approximately parallel to each other.

2. The coin hopper according to claim 1, wherein the output shaft of the motor is coupled with a sun gear of the planetary gear mechanism, and a carrier plate of the planetary gear mechanism is structured in such a way as to be rotated integrally with a driving gear of the first gear train.

3. The coin hopper according to claim 1, wherein the rotation disk is structured in such a way as to be rotated integrally with a driven gear of the first gear train.

4. The coin hopper according to claim 1,
wherein a driving gear of the first gear train is structured in such a way as to be rotated integrally with a carrier plate of the planetary gear mechanism, and a driven gear of the first gear train is structured in such a way as to be rotated integrally with the rotation disk;
rotation of the driving gear is transmitted to the driven gear directly or by way of a first intermediate gear.

5. The coin hopper according to claim 1,
wherein a driving gear of the first gear train is structured in such a way as to be rotated integrally with a carrier plate of the planetary gear mechanism, and a driven gear of the first gear train is structured in such a way as to be rotated integrally with the rotating disk;
rotation of the driving gear is transmitted to the driven gear by way of a first intermediate gear and a second intermediate gear which are coaxially coupled with each other; and
the first intermediate gear is meshed with the driving gear and the second intermediate gear is meshed with the driven gear, thereby transmitting rotation of the driving gear to the driven gear.

6. The coin hopper according to claim 1,
wherein the motor is fixed to the body section in such a way that the output shaft of the motor is oriented downward;
a sun gear of the planetary gear mechanism is placed near the output shaft; and the output shaft is directly coupled with the sun gear.

7. The coin hopper according to claim 1, wherein the output shaft of the motor is connected to a sun gear of the planetary gear mechanism; and a carrier plate of the planetary gear mechanism is placed on a side distant from the output shaft of the motor.

8. The coin hopper according to claim 1, wherein the output shaft of the motor is connected to a sun gear of the planetary gear mechanism;
a carrier plate of the planetary gear mechanism is placed on a side distant from the output shaft of the motor;
and a driving gear of the first gear train is fixed to the carrier plate.

9. The coin hopper according to claim 1, wherein the output shaft of the motor is connected to a sun gear of the planetary gear mechanism;
a carrier plate of the planetary gear mechanism is placed on a side distant from the output shaft of the motor;
a driving gear of the first gear train is fixed to the carrier plate;
a driven gear of the first gear train is structured in such a way as to be rotated to be integrally with the rotating disk; and
rotation of the driving gear is transmitted to the driven gear directly or by way of an intermediate gear.

10. The coin hopper according to claim 1, wherein the first gear train comprises:
a driving gear which is rotated integrally with a carrier plate of the planetary gear mechanism;
a driven gear which is rotated integrally with the rotating disk;
a first intermediate gear and a second intermediate gear which are coupled coaxially with each other are provided for transmitting rotation of the driving gear to the driven gear; the driving gear and the first intermediate gear are placed in a first plane and meshed with each other; and
the driven gear and the second intermediate gear are placed in a second plane which is parallel to the first plane and meshed with each other.

11. The coin hopper according to claim 1, wherein the motor and the rotating disk are horizontally adjacent to each other, and the output shaft of the motor is extended vertically; the output shaft of the motor is coupled with a sun gear of the planetary gear mechanism which is placed under the motor; and a driven gear of the first gear train is placed under the rotating disk.

12. The coin hopper according to claim 1,
wherein the first gear train comprises a driving gear connected to the planetary gear mechanism, a first intermediate gear meshed with the driving gear, a second intermediate gear meshed with the first intermediate gear, and a driven gear connected to the rotating disk;
a diameter of the first intermediate gear is larger than a diameter of the driving gear;
a diameter of the second intermediate gear is smaller than a diameter of the first intermediate gear; and a diameter of the driven gear is larger than a diameter of the first intermediate gear.

13. The coin hopper according to claim 1, wherein the first gear train comprises a first intermediate gear and a second intermediate gear which are coupled together;
a diameter of the second intermediate gear is smaller than a diameter of the first intermediate gear;
the first intermediate gear and the second intermediate gear are rotated by the output of the planetary gear mechanism; and
rotation of the second intermediate gear is transmitted to the rotating disk.

14. The coin hopper according to claim 1, wherein a carrier plate and gears of the planetary gear mechanism are made of synthetic resin, and gears of the first gear train are made of synthetic resin.

15. A compact coin hopper formed from a combination of housing components that are stacked to operatively receive and dispense coins while forming portions of an exterior surface of the compact coin hopper, comprising from a top surface to a bottom surface;
a hopper head for holding coins to be dispensed and supporting a rotatable disk for moving the held coins;
an upper cover for defining an upper opening of a coin outlet;
a base member for defining a lower opening of the coin outlet;
a body member for supporting an electric motor and a rotating disk driving mechanism to drive the rotatable disk for dispensing coins from the hopper head; and
a lower cover for supporting gears driven by the electric motor.

16. The compact coin hopper according to claim 15 wherein the body member is formed of a plastic resin and has an integral internal gear on an open bottom surface with a plurality of inward-pointing teeth formed to operatively interface with a planetary gear mechanism.

17. The compact coin hopper according to claim 16 wherein the rotating disk driving mechanism includes the planetary gear mechanism for generating an output force by reducing the rotational force of an output shaft of the electric motor at a first reduction ratio and a first gear train of a plurality of gears for transmitting the output of the planetary gear mechanism to the rotatable disk after decelerating the output of the planetary gear mechanism at a second reduction ratio.

18. The compact coin hopper according to claim 17 wherein the electric motor has an output shaft and the output shaft of the motor, the rotation axis of the rotating disk and the rotation axis of each of the plurality of gears of the first gear train are arranged not to be coaxially but to be approximately parallel to each other.

19. The compact coin hopper according to claim 18 wherein the output shaft of the electric motor is connected to a sun gear of the planetary gear mechanism;
a carrier plate of the planetary gear mechanism is placed on a side distant from the output shaft of the electric motor;
a driving gear of the first gear train is fixed to the carrier plate;
a driven gear of the first gear train is rotated to be integrally with the rotating disk; and
a rotation of the driving gear is transmitted to the driven gear directly or by way of an intermediate gear.
